(19) United States
(12) Patent Application Publication
(10) Pub. No.: US 2005/0042770 A1
(43) Pub. Date: Feb. 24, 2005

(54) Fluidic functions based on non-wettable surfaces

(75) Inventors: Helene Derand, Taby (SE); Matthew Fielden, Oesundsbro (SE); Cecillia Hellermark, Lidingo (SE); Rickard Kange, Uppsala (SE); Therese Sennefors, Danderyd (SE)

Correspondence Address: FULBRIGHT & JAWORSKI, LLP, 1301 MCKINNEY, SUITE 5100, HOUSTON, TX, 77010-3095, US

(73) Assignee: GYROS AB

(21) Appl. No.: 10/849,321

(22) Filed: May 19, 2004

Related U.S. Application Data
(60) Provisional application No. 60/559,565, filed on Apr. 5, 2004.
(60) Provisional application No. 60/472,924, filed on May 23, 2003.

(51) Int. Cl. G01N 1/10

(52) U.S. Cl. 436/180

(57) ABSTRACT

A method for processing two or more liquid aliquots in a microchannnel structure of a microfluidic device. The microchannel structure comprises a hydrophilic microconduit with a fluidic function and a local non-wettable surface associated with the fluidic function/microconduit. Other aspects comprise a method for producing the fluidic function, which comprises introducing non-wettability on a local surface area S that is associated with the microconduit.

### CROSS-REFERENCE TO RELATED APPLICATIONS

This application claims priority to U.S. Provisional application No. 60/472,924 filed on May 23, 2003 and U.S. Provisional Application No. 60/559,565 filed on Apr. 5, 2004, which are both incorporated by reference herein in their entirety.

### TECHNICAL FIELD

The present invention relates to a method for processing two or more liquid aliquots in a microchannnel structure of a microfluidic device, typically made in plastics. Further aspects relate to a method for producing the fluidic function.

### BACKGROUND OF THE INVENTION

Boundaries defined between wettable surface areas and non-wettable surface areas in microchannel structures/microconduits have previously been utilized in applications where liquid is to be retained on the wettable sides of these boundaries for shorter or longer periods of time. In microfluidics this kind of boundaries has been used in passive valves, anti-wicking functions, vents, liquid-directing functions etc. Local non-wettable surface areas have typically been introduced by patterning a generally wettable (hydrophilic) surface with a non-wettable (hydrophobic) material. See for instance: WO 9958245, WO 0185602, WO 02074438, WO 03018198, and WO 03024598; U.S. Pat. No. 6,926,020, U.S. Pat. No. 6,591,852, U.S. Pat. No. 6,601,613 and U.S. Pat. No. 6,637,463; WO 0190614; WO 9917093; U.S. Pat. No. 4,676,274; WO 0187486; WO 0241996, WO 0242650, and WO 0241995, each of which is incorporated herein by reference in its entirety. Local non-wettable surface areas have also been combined with changes in geometric surface characteristics in e.g. anti-wicking functions and in wells. See unit 7 in WO 02074438 (incorporated herein by reference in its entirety) and the “wells” described in WO 9815356 (incorporated herein by reference in its entirety).

WO 0107161 (incorporated herein by reference in its entirety) describes a “dispensation” plate that has a) one side on which there are larger wettable spots/wells for storing of liquid, b) an opposite side on which there are smaller wettable spots/wells, and c) a transport capillary passing through the plate between each pair of large and small spots/wells. Each wettable spot/well is surrounded by a non-wettable surface area that may be rough.

Relevant techniques for introducing non-wettability on surfaces including surfaces of plastic material have also been described by Rohr et al (Adv. Funct. Mater. 13(4) (2003) 264-270) and in U.S. Pat. No. 6,447,919, both of which are incorporated herein by reference in their entirety.

There is often a desire for passing liquid several times through the same microconduits/fluid functions of a microchannel structure. This may negatively affect the flow-controlling function of a local non-wettable surface area due to adsorption of surface-active components to the area (drawback 1) and/or destruction/degrading of the area by action of “aggressive” components in the liquid in the case the area is in the form of a coat (drawback 2).

Both drawbacks mean a risk for insufficient function next time the local non-wettable surface area/function is contacted with liquid.

A variant that minimizes the first drawback has been presented in our co-pending application SE 0301539-3 and U.S. Ser. No. 60/472,924 (both filed May 23, 2003) (both of which are incorporated herein by reference in their entirety) and the corresponding International Patent Application. The existence of the second drawback has been indicated in International Patent Application PCT/SE2004/000109, which is incorporated herein by reference in its entirety.

The generally accepted way of avoiding these drawbacks has been to design each microchannel structure with several separate inlet arrangements, each having its own fluidic functions with local non-wettable surface areas. See for instance WO 02075775, WO 02075776, WO 02075312, WO 030993802, PCT/SE2004/000440 and PCT/SE2004/000441 (each of which is incorporated herein by reference in its entirety).

Many liquid solutions used in the field of the present invention contain the “harmful” components discussed above. Biologically derived sample liquids, for instance, typically contains large bulks of components exhibiting peptide structure and/or lipid structure and/or carbohydrate structure. Reactants/reagents typically exhibit peptide structure (including for instance oligo/polypeptides that includes proteins). Detergents are often present in liquids used for washing, diluting reactants including analytes and other samples. It would therefore be highly beneficial to design microfluidic functions that have a minimized risk for failure due to the drawbacks discussed above.

The second drawback should be accentuated for fluoropolymer layers that often display poor adhesion to other materials, for instance plastic materials.

### BRIEF SUMMARY OF THE INVENTION

The first aspect of the invention relates to a method for processing two or more liquid aliquots in a microchannnel structure of a microfluidic device, typically made in plastics. The microchannel structure comprises a hydrophilic microconduit with a fluidic function (I) that is based on a boundary between a local non-wettable surface area and the wettable part of a generally wettable surface of an inner wall of the microconduit. The fluidic function is typically selected amongst passive valves, anti-wicking functions, vent functions, and liquid-directing functions. The non-wettable local surface area is a) a part of an inner wall of the microconduit/microchannel structure, or b) present on the outer surface of the microfluidic device and associated with an opening of the microconduit/microchannel structure (to ambient atmosphere).

The microfluidic device comprises one or a plurality of the microchannel structure, i.e. the microchannel structures of the plurality are functionally equal which includes that they can be used in parallel, i.e. essentially the same assay protocol can be carried out simultaneously in each of them.

The second aspect of the invention is a method for producing the fluidic function discussed above. This method comprises introducing non-wettability on one or more local surface area(s) S, i.e. the same areas as the local non-wettability surface areas but without the non-wettable surface characteristics to be introduced.

Other aspects of the invention relate to the microfluidic device that is used in the first aspect and a microfluidic device that has a fluidic function of the type obtained according to the second aspect.

The use of a microfluidic device corresponds to the first aspect and generally comprises transportation and processing of one or more liquid aliquots through and between functional parts of a microchannel structure of the device. The purpose of the transport/processing is typically to carry out a predetermined process protocol, for instance for analytical or preparative purposes. Typical analytical purposes are assaying for one or more constituents (=analytes) of a sample. Preparative purposes include separation, isolation, purification, enrichment etc of one or more components of a liquid and also synthesis of organic and/or inorganic compounds.

Certain objects of the present invention provide a stable microfluidic function of the type discussed above. Stability refers to ability to withstand prolonged and/or repeated contact with aqueous liquids that contain water-miscible organic solvents and/or surface active components, such as bioorganic molecules comprising peptide structure, lipid structure etc and/or surfactants/detergents that may be anionic, cationic, or non-ionic.

Other objects lower the risk for failure of microfluidic functions that are based on non-wettable surface breaks. This object is primarily applicable to protocols in which a liquid aliquot is passing a fluidic function that comprises a non-wettable surface break subsequent to the passage of a liquid aliquot that contains the above-mentioned destabilizing components.

Yet further, another object is to increase the adherence of fluoropolymers to plastic surfaces, in particular to wettable plastic surfaces including plastic surfaces the wettability of which has been increased (hydrophilized).

Still further, another object is to provide methods for manufacturing the microfluidic functions, and the microchannel structures and microfluidic devices containing them.

Achievement of these objects will facilitate the carrying out of two or more essentially identical protocols in a timely parallel fashion in the same microfluidic device with a lowered risk for failure of microfluidic functions that are based on non-wettable surface breaks. The consequence will be increased chances for obtaining increased yields of reliable results, for instance per microfluidic device containing a plurality of microchannel structures.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a part of the microfluidic device that has been used in the experimental part for testing the non-wettable surface breaks according to the invention. The structures are arranged in arc-shaped segments around the center of a circular microfluidic device. See for instance FIG. 7 of WO 02075775, which is incorporated herein by reference in its entirety.

### DETAILED DESCRIPTION OF THE INVENTION

I. Definitions

The expressions “wettable” and “non-wettable” surfaces are relative. In the context of the instant invention, the term “non-wettable surface” therefore means a surface area that has a water contact angle that is larger than the water contact angle of an abutting “wettable surface area”. The difference in water contact angles between a non-wettable and an abutting wettable surface area is thus typically ≧5°, such as ≧20° or ≧35° or ≧50°. In most cases the water contact angle of a wettable surface is ≦90° and of a non-wettable surface is ≧90°, respectively. Non-wettable compounds or agents are substances that when applied as a coat on a smooth surface gives the surface a water contact angle ≧90°, such as ≧100° or ≧110°.

A “local non-wettable surface area” is local in the sense that the area is delineated in at least one direction (one end) along the microconduit by a wettable surface area that is present in the same inner wall as the local non-wettable surface area. In other words a microchannel structure comprising the above-mentioned fluidic function has at least one opening to which an inner local non-wettable surface area does not extend. Local non-wettable surface areas are also called non-wettable surface breaks or non-wettable breaks and typically have water contact angles ≧90°, such as ≧100° or ≧110° or ≧120°.

The term “hydrophilic microconduit” means that an aqueous liquid, such as pure water, is capable of being transported within the microconduit by capillary force, i.e. by self-suction, up to a first valve position and/or between two valve positions (presuming that the valve functions also are associated with venting capability). A hydrophilic microconduit is enclosed, i.e. is not in the form of an uncovered groove, and may or may not have one or more openings to ambient atmosphere. Capillary force in this context implies that two, three, four or more inner walls have generally wettable inner surfaces with a water contact angle that as a rule is <90°, such as ≦70° or ≦55° or ≦45° or ≦30° or ≦20°, possible with one or more non-wettable surface breaks. If one or more of the inner walls are generally non-wettable this may be compensated by a lower water contact angle for the wettable inner walls.

Contact angles refer to values at the temperature of use, typically +21° C., are static or advancing. Advancing angles typically are higher than static angles. Static angles are measured by the method given in WO 0056808 (incorporated herein by reference in its entirety). Advancing angles are measured as given in the experimental part.

II. The Invention

The present inventors have recognized that non-wettable surfaces that exposes fluoro groups (F—), such as in fluoropolymers, and rough surfaces provide nice possibilities for minimizing the drawbacks discussed above. The present inventors have also recognized that these two features, either alone or in combination, will reduce the need for separate fluidic functions/microconduits for the introduction of different liquids into a microchannel structure. These recognitions will enable safe passage of one, two, three or more liquid aliquots through the same hydrophilic microconduit/microfluidic function as a previous liquid that contained the above-mentioned harmful components. Nice improvements have at the priority date in particular been obtained for plastic surfaces that are made wettable (water contact angle ≦90° as discussed above) before the coat/layer that exposes the fluoro groups is formed on the surface. Fixatable fluoropolynmers are preferred.

In certain embodiments, the hydrophilic microconduit may be branched, unbranched, bent or straight. The fluidic function used in the first aspect and formed in the second aspect may comprise a local non-wettable surface area in one, two or more of the inner walls of the hydrophilic microconduit (inner wall means anyone of a side wall, a top wall and a bottom wall).

III. Use of a Microfluidic Device for Processing Two or More Aliquots of Liquid

The first aspect is a method for transporting and/or processing two or more liquid aliquots in a microfluidic microchannel structure. The most general characteristic feature is a combination of two main features—the first one relates to the steps of the method and the second one to the microfluidic function/device as such. A local non-wettable surface area shall expose immobilized fluoro groups (═F—) and/or comprise a rough part.

The invention implies that it will be easier to carry out large numbers of parallel runs of essentially the same protocol in the same microfluidic device with a low number of failures. Accordingly in optimal and also preferred variants the protocol at issue should be carried out in parallel in the same microfluidic device for ≧5 microchannel structures, such as ≧10 or ≧15 or ≧25 microchannel structures, typically with no failure of the type discussed above for typical sets of parallel runs. Parallel in this context means that at least the sequence: “step (i) followed by step (ii)” is carried out simultaneously in the given number of microchannel structures. The advantages will become more apparent for an increasing number of local non-wettable surface areas and/or of boundaries per microchannel structure or per flow path that is common for transportation and processing of the aliquots. Thus the largest advantages will be at hand if each microchannel structure/common flow path of a microfluidic device comprises two, three, four, five, six or more local non-wettable surface areas and/or boundaries per microchannel structure/common flow path. The same also applies to the fluidic functions discussed herein. The local non-wettable surface areas do not need to be identical and are in fact often different from each other.

A. Method Steps

The first main characteristic features of the method comprises the steps of:
(i) passing a liquid aliquot (I) that contains
   (a) an organic solvent, and/or
   (b) one or more components that are capable of adsorbing to a local non-wettable surface area
   through the microconduit, and
(ii) passing another liquid aliquot (II) through the microconduit.

The method according to this aspect is typically part of an analytical protocol that is intended for assay purposes. In this case aliquot I or an aliquot of a subsequent or a preceding step, for instance aliquot II, may be a sample containing an analyte, i.e. an entity for which a feature is to be characterized, for instance amount, activity, kind, structure etc. An analyte-containing aliquot (sample) and/or an analyte as such typically derive from biological material, for instance from a body fluid such as urine, blood (serum, plasma, red blood cells, lymphocytes/leukocytes, thrombocytes, other dissolved or particulate blood constituents etc), lacrymal fluid, saliva, feces, semen, cerebrospinal fluid, lymphatic fluid etc (body fluid samples); or from whole or intact cells, tissue etc, such as cell culture supernatants, cell homogenates, tissue homogenates etc. The biological material may originate from an animal, a plant, a microorganism etc. Environmental samples are included in “deriving from biological material”. The analyte may be an organic or inorganic substance including also substances that are both organic and inorganic. The analyte may be a bio-organic compound and as such exhibit one or more structures selected amongst peptide structures including also poly-/oligo-peptide structures and protein structures, carbohydrate structures, lipid structures, steroid structures, hormone structures (of any living species), nucleotide structures including nucleic acid structures and nucleoside structures etc. The term analyte also includes complex structures such as parts of animal and plant tissue, complete cells (viable as well as more or less inactivated cells) and particulate parts thereof etc.

Typical analytical protocols are given in WO 02075775, WO 02075776, WO 02075312, WO 03093802, PCT/SE2004/000440 and PCT/SE2004/000441 (each of which is incorporated herein by reference in its entirety). Thus the protocol may define an affinity assay, (such as a bioaffinity assay), a catalytic assay such as an enzyme assay, a sample preparation protocol etc. Affinity assays may be divided into heterogeneous and homogeneous affinity assays, each of which in turn may be categorized into competitive/inhibition assays or non-competitive assays, such as sandwich assays etc. Similarly catalytic assays may be divided into heterogeneous and homogeneous catalytic assays, competitive or non-competitive catalytic assays, etc. The term “catalytic assays” as such coincides with the terminology used in WO 03093802, which is incorporated herein by reference in its entirety. The method may also be part of a protocol having preparative purposes.

The method comprises in certain variants that one or more additional liquid aliquots may pass through the hydrophilic microconduit before step (i), and/or between steps (ii) and (ii), and/or after step (ii). The liquids contemplated are typically aqueous. Their surface tension is typically ≦30 mN/m or ≦25 mN/m, such as from 10 mN/m and upwards. The aliquots may have equal volume or two or more of the aliquots may have different volumes. Liquid aliquots other than aliquot I, for instance aliquot II, may or may not contain a component of type (a)-(b) above.

Type (a) components primarily refer to water-miscible organic liquids, such as methanol, ethanol, isopropanol, t-butanol, dimethyl sulphoxide, acetonitril, N,N-dimethyl formamide etc. Organic solvents have a stronger tendency than water to negatively affect a non-wettable layer. The advantages with respect to failure of non-wettable breaks typically increase with amount of organic solvent in a liquid aliquot used, such as aliquot I and/or aliquot II. Thus by use of the invention the content of organic solvent may be ≧1%, such as ≧5% or ≧10% or ≧20% or ≧30 or ≧40% provided that the kind and amount of organic solvent is selected not to deform the plastic material in which the microchannel structures have been fabricated. Accordingly the amount of organic solvent in a liquid aliquot, such as aliquot I and/or II, typically is selected to be ≦100%, such as ≦90% or ≦80 or ≦60%. Percentage amounts refer to w/w.

Type (b) components are typically selected amongst surface-active components, such as synthetic surfactants (detergents) and organic, biomolecules (bioorganic molecules) that exhibit peptide structure and/or lipid structure and/or carbohydrate structure, for instance. Surfactants include anionic, cationic, and non-ionic surfactants. As a rule surface-active components have hydrophilic and hydrophobic parts. Bio-organic molecules may be present in an aliquot as a reactant or as bulk components deriving either from native sample or added separately, for instance. Adsorption of a surface-active component to a local non-wettable surface area typically increases the risk for malfunctioning of the fluidic function(s) concerned. When present in a liquid aliquot such as aliquot I and/or aliquot II, the total amount of surface-active components or of different types of such components typically is found within the range 0.1 μg-200 mg/ml, such as 1 μg-100 mg/ml. The exact amount will depend on type of component(s), type of aliquot etc meaning that these limits in principle may be applicable to any of the surface-active components discussed herein.

Samples that derives from biological material of the types discussed above may be used as aliquot I or aliquot II and used in undiluted form, i.e. typically containing larger amounts of the native harmful components, or in slightly diluted form, such as diluted in the interval ≦1:10000, such as ≦1:1000 or ≦1:100 or ≦1:10 or ≦1:5 or ≦1:2.

The advantages with the invention with respect to hydrophobic breaks typically increase with increasing amount of surface-active components in a liquid aliquot used, such as aliquot I and/or aliquot II. Thus by use of the invention the content of surface active components of the type discussed in the preceding paragraphs may be ≧1 μg/ml, such as ≦10 μg/ml or ≧100 μg/ml or ≧1 mg/ml or ≧10 mg/ml.

At least one of liquid aliquot I and/or liquid aliquot II and/or any of the other liquid aliquots passing through the hydrophilic microconduit may contain a reactant necessary for carrying out the protocol intended. In analytical protocols the analyte is typically a reactant and non-analyte reactants are reagents. Reagents may exhibit structures selected amongst the same kind of structures as outlined for the analyte and/or be a biological material. In certain variants of the first aspect, aliquot I and/or aliquot II contains a reactant. In at least one of them the reactant is an analyte in the case the protocol is analytical.

The fluidic function in the hydrophilic microconduit may be a valve function. One or more of the liquid aliquots passing through the microconduit may be paused at the valve function, for instance every aliquot that is passing through the microconduit after aliquot I or at least one or both of aliquots I and II. A paused and/or a non-paused liquid aliquot may contain one or more of the above-mentioned components of type (a) and/or (b) and/or of the reactants discussed above.

Liquid aliquots that do not contain reactants are often used as diluents, washing liquids, buffering liquids etc. These aliquots typically only contain constituents that do not participate in the assay reactions or other reactions of the protocol to be performed (i.e. are inert). Some of the constituents may be components of type (a) or type (b).

One, two, three or more washing aliquots may be passed through the hydrophilic microconduit in sequence between two aliquots containing reactants, for instance between an aliquot (sample) containing an analyte and an aliquot containing some other reactant (i.e. a reagent), or before a detection step. In this case there is typically a preceding step involving capture of a reactant to a solid phase which is retained within a downstream part of the microchannel structure, e.g. downstream one or more local non-wettable surface area that are parts of a valve function and/or an anti-wicking function, for instance. This part may or may not be part of the hydrophilic microconduit containing the local non-wettable surface area(s).

B. Local Non-Wettable Surface Areas that Expose Fluoro Groups

The free valence of a fluoro group (F—) that is exposed on local non-wettable surface areas is binding to a carbon atom, in particular to a sp³-hybridized carbon atom, such as a carbon atom directly binding to only one or only two other carbon atoms (primary and secondary carbon, respectively). The fluoro group may be part of a CF₃—, CHF₂—, CH₂F—, —CF₂—, or —CHF— group in which a free valence is binding to a carbon atom that may be sp³- or sp²-hybridized. In preferred variants the fluoro group is part of a fluoropolymer that has been coated or otherwise introduced on local surface area(s) S. For instance as outlined by Rohr et al (Adv. Funct. Mater. 13(4) (2003) 264-270) and U.S. Pat. No. 6,447,919, both of which are incorporated herein by reference in their entirety. In an alternative variant the fluoro groups may be introduced by covalently immobilizing a reactive low molecular weight compound containing fluoro groups to the local surface area(s) S. Low molecular weight in this context typically contemplates ≦2000 dalton, such as ≦1000 dalton. In still another variant the hydrophilic microconduit/microchannel structure(s) of the device is fabricated in a fluoropolymer plastics. The surfaces of the conduits/channels are then subsequently made wettable (hydrophilized) outside the local surface area(s) S (=the local non-wettable surface area(s)).

The fluoropolymer of a local non-wettable surface area is typically a polymerization product of identical or different monomers, each of which comprises a polymerizable alkene structure, i.e. unsaturation such as a carbon-carbon double or triple bond, or other polymerizable groups. At least one, typically all, of the monomers used comprises one or more fluoro-containing groups (fluoromonomers). Fluoropolymers obtained by other polymerization routes may also be used.

Suitable fluoro-containing alkene monomers comply with formula
CR₁R₂═CR₃R₄
in which at least one of R₁₋₄ contains fluoro and the others are selected from fluoro, lower alkyls and hydrogen. R₁₋₄ may also pairwise form a cyclic structure that contains one or both of the carbon atoms of the unsaturation. Fluoro-containing groups R₁₋₄ may comply with the formula —BₙR where n is 0 or 1, B is a bivalent organic group and R is a fluoro-containing group that in typical variants is monovalent or bivalent. Two or more of the groups R₁₋₄ may be equal or different, i.e. there may also be two or more of the group —BₙR that are equal or different (if present).

Bivalency of R in a group —BₙR means a cyclic structure comprising one or both of the carbons of the unsaturation and/or at least a part of B (only if n=1). The first valence thus binds to B or to a carbon of the unsaturation (if n=0). The second valence binds to B in another group —BₙR by replacing R in this group or directly to one of the unsaturated carbons by replacing a R₁₋₄ group at this carbon.

Lower alkyl in this text will primarily contemplate C₁₋₆ alkyl that may be straight, branched or cyclic. Typical lower alkyls are methyl, ethyl, propyl, butyl, pentyl and hexyl including cyclic and branched forms such as isomeric forms. The corresponding alkylenes are examples of typical lower alkylenes.

B typically contains a heteroatom selected amongst oxygen, nitrogen and sulphur, typically in a terminal position, for instance linking B to a carbon atom of the unsaturated group and/or to R. B may also contain one or more interior heteroatoms. Typical Bs are selected amongst ester-containing groups e.g. —C(═O)O— and —OC(═O)—, ether-containing groups e.g.—O—, and amide-containing groups e.g. —C(═O)NR′— and —NR′C(═O)—. R′ is hydrogen or lower alkyl.

R is typically a fluoro-substituted alkyl group that may be straight, branched or cyclic and typically comprises 1-20 carbon atoms, such as 3-20 or 3-15 carbon atoms (e.g. sp³-hybridized). R typically comprises two or more fluoro atoms, i.e. is a poly fluoro alkyl group, and is in certain variants devoid of hydrogen atoms, i.e. is a perfluoro alkyl group. In most preferred variants an R group comprises at least one trifluoro methyl group and/or 1-19, such as 2-19 or 2-14 difluoro methylene groups or monofluoro methylene groups. R may also be a sole fluoro group, for instance with n=0.

Thus, the fluoropolymer typically comprises identical or different monomeric units
—CR₁R₂—CR₃R₄—
in which R₁₋₄ has the same meaning as in the preceding paragraph.

Preferred fluoropolymers are selected amongst those that comply with the formula given above, with utmost preference for those in which R₁₋₂ are hydrogens, R₃ is methyl or hydrogen, R₄ is BₙR where n is 1, B is an ester group (—C(═O)O— in which the right valence binds to R and the left valence to the unsaturation) and R is a polyfluoro, such as a perfluoro, C₇₋₁₅ alkyl group. See the experimental part.

The fluoro groups are introduced on the local surface area(s) S by techniques well-known in the field including also related techniques in which non-covered structures are patterned with non-wettable material. See for instance WO 9958245, WO 0185602, WO 9917093, each of which is incorporated herein by reference in its entirety. For fluoropolymers these techniques typically comprise treatment with a fluoropolymer composition selected from the same compositions as the fixatable composition used in the second aspect of the invention. The steps used comprise in principle the steps (i) and (ii) of the second aspect except that the fluropolymer does not need to be fixatable to the same extent as in the second aspect. See also Rohr et al (Adv. Funct. Mater. 13(4) (2003) 264-270) and U.S. Pat. No. 6,447,919, each of which is incorporated herein by reference in its entirety. In preferred variants the fluoropolymer may be selected and post-treated (step (iii) as in the second aspect.

C. Rough Non-Wettable Surface Areas

A local non-wettable surface area may comprise a rough part to better withstand contact with liquids of the kinds discussed above. See our copending applications SE 0301539-3, U.S. Ser. No. 60/472,924 (both filed May 23, 2003) and their corresponding International Patent Application filed in parallel with this application, all of which hereby are incorporated by reference in their entirety.

The rough part may coincide completely or partly with a local non-wettable surface area. If the rough area is only a part of the non-wettable surface area it is preferably aligned along the boundary between the local non-wettable surface area and the abutting wettable surface, possible at a distance from the boundary.

Roughness may be expressed as arithmetic average roughness (Rₐ), which is also known as arithmetic average (AA), center line average (CLA), and arithmetical mean deviation of the profile. This kind of roughness corresponds to the area between the roughness profile and its mean line, or the integral of the absolute value of the roughness profile height over the evaluation length:

$${R}_{a} = \frac{1}{L} {\int }_{0}^{L} \vert r ( x ) \vert ⅆ x$$

When evaluated from digital data, the integral is normally approximated by a trapezoidal rule:

$${R}_{a} = \frac{1}{N} {\sum }_{n = 1}^{N} \vert {r}_{n} \vert$$

Graphically, the average roughness is the area between the roughness profile and its center line divided by the evaluation length (normally five sample lengths with each sample length equal to one cutoff).

In the formula above L is evaluation length, r(x) is roughness at position x, N is total number of values and rₙ is roughness at pixel n.

Rough surfaces in the context of the invention have roughness Rₐ≧0.01 μm. Preferred/optimal roughness Rₐ (also called effective roughness) thus are found within the intervals ≧0.01-15 μm, such as 0.1-15 μm or 0.5-10 μm. Areas that are not rough are smooth.

The optimal interval for roughness in the invention depends on a) the liquid to be used, for instance its surface tension, b) the dimensions of microconduits/microcavity etc with which the rough part is associated. Typically experimental testing is required for optimization. In principle roughness may be introduced on a smooth surface in two major ways: 1) additive roughening, and 2) destructive roughening. Both ways encompass variants such as so-called mechanical and/or chemical roughening. Roughness may also be introduced when a surface is initially formed, for instance by moulding, embossing, cutting etc.

Mechanical additive roughening typically comprises that particles are randomly distributed and adhered to a surface, for instance comprising one or more local surface areas S. The particles used typically correspond to a population of particles having a mean diameter ≦100 μm, preferably ≦15 μm, such as ≦10 μm or ≦5 μm or ≦1 μm, and ≧0.01 μm, such as ≧0.1 μm or ≧0.5 μm or ≧1 μm ≦100 μm. In the case the surface is located within a microchannel structure; the upper limit for the mean diameters is typically ≦10%, such as ≦5%, of the largest and/or of the smallest cross-sectional dimension (width or depth) at the rough surface in the microchannel structure. These particle sizes refer to the particles as they appear on the final non-wettable surface, e.g. to particle agglomerates if the particles tend to adhere to each other. The particles are typically in the shape of spheres or spheroids, i.e. beaded. Alternatively the particles may have irregular forms. In the case of irregular forms and spheroids the diameters above refer to the “hydrodynamic” diameter.

The particles may expose a wettable or a non-wettable surface and be porous or non-porous and/or comprise none, one, two or more enclosed holes (hollow particles) etc. In the case the particles are applied in dispersed form to the surface there may be advantages in combining liquid properties with density and/or the size of the particles such that the particles are maintained suspended during application to the surface. Typical particle material includes a) inorganic material such as glass, e.g. borosilicate glass, silica, metal, metal oxide, graphite etc, and b) organic material, such as organic polymers based on monomers comprising polymerizable unsaturation and/or other groups that permit polymerization.

There are a number of ways to adhere particles to a surface. The particle as such and/or the surface may be self-adhering to each other and/or pretreated with an adherence-promoting agent. This agent may be an adhesive or it may be a solvent partially dissolving an outer layer of the surface or the particles. Alternatively, particles may be distributed on the surface together with a suitable adherence-promoting agent. Moreover, non-sticky particles may be applied to the surface followed by deposition of an adherence-promoting coating.

The application of the particles and the adherence-promoting agent to a surface is typically by printing, spraying, painting and the like. In a preferred variant the particles are distributed on the surface in dispersed form together with an adherence-promoting agent dissolved or dispersed in the liquid phase of the dispersion. The adherence-promoting agent in this variant is typically a polymer, but also non-polymeric compounds may be used provided they are able to promote adherence. Suitable polymers may be found amongst polymers that are based on monomers comprising polymerizable unsaturation and/or other groups that permit polymerization. The adherence-promoting agent may be wetting or non-wetting.

Creation of rough non-wettable surfaces by application of particles and non-wetting polymers is described in U.S. Pat. No. 6,447,919, which is incorporated herein by reference in its entirety.

Additive chemical roughening comprises that a chemical or physical reaction is carried out on a surface or in the proximity of the surface, leading to deposition of material on the surface, for instance as precipitates/crystals.

Destructive mechanical roughening comprises methods such as grinding, blasting, etc. In destructive chemical roughening the surface is degraded in local spots to create small wells, indentation, protrusions and the like. This kind of roughening may be carried out by etching, irradiation etc.

After the roughening process the surface may be provided with a surface coating of the desired non-wettability. This may in particular be important if the starting surface, the particles, an adhesive, and/or a used adherence-promoting agent is wetting. The method and agents used for introducing a non-wetting coating at this stage follow the same principles as is well-known in the field of coating. Typically the roughened surface is then coated with a non-wetting compound, for instance a fluorinated hydrocarbon, paraffin and the like. The preferred surface coatings typically comprises polymers or copolymers that may or may not have been cross-linked, for instance based on ethylene, propylene, butadiene, fluorinated alkenes, etc. Suitable non-wetting polymers can be found amongst polymers that are based on monomers comprising polymerizable unsaturation and/or other groups that permit polymerization. See the experimental part. Preferred polymer for introducing non-wettability are given in the experimental part and can also be found amongst those that are described in U.S. Pat. No. 6,447,919, which is incorporated by reference herein in its entirety.

D. Microfluidic Functions Comprising Local Non-Wettable Surface Areas

The non-wettable local surface area is typically part of a passive valve, an anti-wicking function, a vent, a liquid-directing function and the like. The area may or may not comprise a rough part.

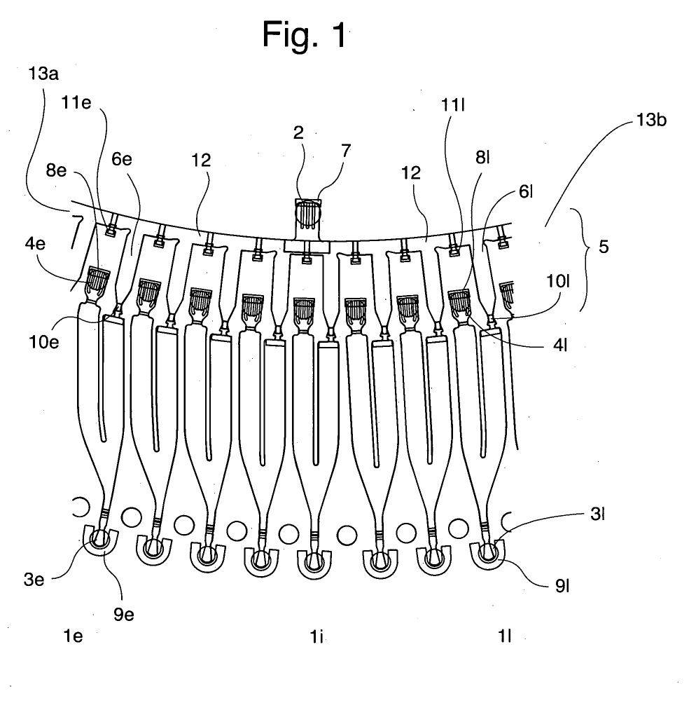

Passive valves, anti-wicking functions and vents that utilize the innovative principle are typically present in microconduits of microchannel structures in which the intersections of inner side-walls define one, two, three, four or more length-going edges. See for instance FIG. 1 of WO 02074438, which is incorporated herein by reference in its entirety. The boundary between the local non-wettable surface area and a wettable part of an inner wall typically stretches between two edges in one, two or more of the inner walls. The direction of the boundary is preferably essentially perpendicular to the flow direction (i.e. within 90°±45°).

In a passive valve the local non-wettable surface area is typically present as a non-wettable zone in one, two, three, four or more of the inner walls at the position of the valve. The non-wettable zone may coincide with a local change in geometric surface characteristics, either in the same inner wall, in an opposing and/or intersecting inner wall. The latter change is typically in the form of ridges, projections, protrusions, grooves and the like and preferably stretches between two edges in one, two or more inner walls (and are also essentially perpendicular to the flow direction). The non-wettable zones in opposing inner walls should be at essentially the same position along the flow path/microconduit. This kind of valve is typically present at outlet ends of volume-metering microcavities, reaction microcavities, outlet ends of microconduits etc, i.e. the same positions as for conventional passive valves that are based on a boundary between a wettable and a non-wettable surface area. This means that the non-wettable surface areas may be surface areas 205a,b in FIG. 2; 321a,b,c,d,e, 322, 323 and 335 in FIG. 3; 408 and 423 in FIG. 4; 607, 608, 610 in FIG. 6; 809 in FIG. 8; 1007 in FIG. 10; 1206, 1208 in FIG. 12; and 1310, 1313 in FIG. 13a of WO 02074438, which is incorporated herein by reference in its entirety.

In an anti-wicking function, the local non-wettable surface area typically is present as a zone in one, two, three, four or more inner walls. The non-wettable zones in opposing inner walls are typically slightly displaced relative to each other (in the flow direction) if a simultaneous valve function is to be minimized. The non-wettable zone may partly or completely coincide with a local change in geometric surface characteristics of the same kind as described above for a passive valve. Anti-wicking functions are typically present immediately upstream a single volume-metering microcavity or between volume-metering microcavities that define a distribution manifold, and at other positions where it is important to keep undesired liquid transport by wicking at a minimum. This means that the non-wettable zone may be the surface areas 321g, 314 in FIG. 3; 426 in FIG. 4b; 804/805 in FIG. 8a; 1106/1107 in FIG. 11b; 1209 in FIG. 12; and 1312 in FIG. 13 of WO 02074438, which is incorporated herein by reference in its entirety. Anti-wicking functions that comprise local non-wettable surface areas are in general also associated with inlets and outlets of liquid retaining microcavities. See for instance WO 03018198, which is incorporated herein by reference in its entirety. See also below.

A microconduit that comprises a vent function according to the invention is typically branched with a main microconduit for liquid transport and a branch microconduit through which venting directly or indirectly is taking place (venting microconduit) to ambient atmosphere. Essentially no liquid transport is taking place through this kind of venting microconduit. The local non-wettable surface area is typically present as a zone or stretch in the venting microconduit, preferably starting at the branching point and possibly ending at the outlet end of the venting microconduit. The non-wettable zone may thus be present in the hydrophobic surface areas 208 in FIG. 2; 321,336 in FIG. 3, and 406 in FIG. 4 of WO 02074438 which is incorporated herein by reference in its entirety.

Passive valves and vents that are based on a boundary between a wettable and a non-wettable surface area typically also comprise an anti-wicking function. See for instance the liquid-retaining microcavities described in WO 03018198, which is incorporated herein by reference in its entirety, where the outlet end of this kind of microcavity comprises a combined valve/anti-wicking function or a combined vent/anti-wicking function.

Liquid-directing functions that are based on the innovative principle may be present within a microfluidic device, for instance at a branching in a microchannel structure or between volume-metering microcavities of a distribution manifold where they assist splitting of a larger liquid aliquot into smaller aliquots. This means that the local non-wettable surface area may be present in the surface areas 205a, 208 in FIG. 2; 321,336 in FIG. 3; 405, 406, 408 in FIG. 4; and 610 in FIG. 6 of WO 02074438, which is incorporated herein by reference in its entirety. See also liquid routers as defined in SE 0302650-7, SE 0400071-7, and U.S. Ser. No. 60/508,508 each of which is incorporated herein by reference in its entirety.

Other kinds of liquid-directing functions according to the invention may be present on the outside of a microfluidic device and associated with openings to ambient atmosphere (inlet and/or outlet ports). Liquid-directing functions at an inlet port may assist in guiding liquid into a microchannel structure. Liquid-directing functions at an outlet port may assist in retaining liquid in the port and/or within the device. The outlet port may thus be solely for venting or for evaporation and collection of non-volatile material in the port, for instance. The local non-wettable surface area may thus be present in the surface areas 321 of FIG. 3; 1105 of FIG. 11; and 1210 of FIG. 12 of WO 02074438 (which is incorporated herein by reference in its entirety); and the surface areas 1032 in WO 02075775 (which is incorporated herein by reference in its entirety).

The local non-wettable surface area or zone inside a microconduit may extend in the flow direction along a distance that is in the interval from 0.1 times to 10, 100, 1000 or more times the width or depth of the microconduit. Comparison is made with the width and/or depth at the upstream or downstream end of the local non-wettable surface area concerned.

Boundaries between a wettable surface and a non-wettable surface may define an array of wettable spots on a non-wettable surface or an array of non-wettable spots on a wettable surface. Arrays of wettable spots may be used to collect liquid aliquots, for instance in the form of minute drops, with one aliquot or drop on each spot. In the case the array is open to ambient atmosphere the liquid will evaporate thereby concentrating solutes to the hydrophilic spots. This kind of design has been described as surfaces 1011 and 1012 of FIG. 7b in WO 02075775 (which is incorporated herein by reference in its entirety). The boundary may be associated with a local change in geometric surface characteristics, for instance to define a well that will improve retaining of an aqueous aliquot as outlined in WO 02075775 (1011 and 1012 of FIG. 7b). Additional kinds of local non-wettable surface areas to which the innovative principle may be applied are given in WO 9958245, which is incorporated herein by reference in its entirety.

The hydrophilic microconduit may also comprise a combination of local non-wettable surface areas that define a larger functional unit of the types discussed below under the heading “General Features of Microfluidic Devices”.

The hydrophilic microconduit may thus comprise a so called liquid retaining microcavity (6 . . . e . . . l . . . ) which is a microcavity for liquid having an outlet end with a passive valve (10 . . . e . . . l . . . ) or vent defined by one or more of the local non-wettable surface areas discussed herein. This valve/vent function is typically combined with an anti-wicking function (11 . . . e . . . l . . . ) upstream the valve function, for instance by the presence of one or more local non-wettable surface areas in association with an inlet end of the microcavity. This combination of fluidic functions around a microcavity will be capable of minimizing losses due to evaporation and wicking from a liquid volume retained in the microcavity. If combined with an overflow microconduit, starting at the same level as (microconduits at the extremes 13a and 13b) or between the anti-wicking function and the valve function, for instance at the inlet end of the microcavity and typically ending in a valve function (valve function in the microconduits at the extremes 13a and 13b), the complete unit will be particularly useful for defining liquid volumes within a microfluidic device (volume-defining unit). The valve at the end of the overflow microconduit may be passive, preferably defined by a local non-wettable surface area of the type discussed herein. Two or more liquid retaining microcavities of this kind may be serially linked together, and be part of a distribution manifold in which each microcavity is part of a microchannel structure that receives liquid via the outlet end of the microcavity and not via the outlet ends of the other microcavities. This is illustrated in FIG. 1 in which each of the retaining microcavities (6 . . . e . . . l . . . ) only delivers liquid to only one of the microchannel structures (1 . . . e . . . l . . . )., for instance microcavity 6e to microchannel structure 1e.

Liquid retaining microcavities that are part of the hydrophilic microconduit may be of the type described in WO 03018198 (which is incorporated herein by reference in its entirety). Typical liquid retaining microcavities are reaction microcavities, microcavities for storing a liquid aliquot, premixing microcavities, collecting microcavities for mixed aliquots (e.g. at the end of a mixing microconduit), volume-metering microcavities, detection microcavities, overflow microconduits etc. See also WO 02074438 and SE 0400848-8, the corresponding US provisional application filed on the same day and their corresponding International Patent Application filed in parallel with this application, each of which is incorporated herein by reference in its entirety.

A volume-defining unit that comprises a volume-metering microcavity typically is part of an inlet arrangement. The volume-defining unit/inlet arrangement may be part of a single microchannel structure or common to two or more microchannel structures. In the latter case the unit typically is a distributing manifold with one volume-metering microcavity for each of the microchannel structures the unit is common for. See for instance unit 3 (FIGS. 4a-c), unit 11 (FIG. 12) and unit 12 (FIGS. 13a-b) in WO 02074438 (which is incorporated herein by reference in its entirety), and FIG. 7 in WO 02075775 (which is incorporated herein by reference in its entirety), and unit C (FIGS. 3a-c) and unit E (FIG. 5) in WO 03018198 (which is incorporated herein by reference in its entirety).

E. General Features of Microfluidic Devices

A microfluidic device is a device that comprises one or more microchannel structures in which liquid flow is used for transporting and processing liquid aliquots that contain various kinds of reactants, analytes, products, samples, buffers and/or the like. Processing in this context means operations such as performing chemical and/or biological reactions, synthesizing, isolating, purifying, separating, fractionating, concentrating, diluting, mixing, volume-metering/defining, heating, cooling etc. The mere transporting of a liquid within a microchannel of a device does not qualify the device to be a microfluidic device. Typically at least some kind of fluidic function, such as a valve, needs to be present in the device and used, including also processing of the liquid.

The volumes of the aliquots are typically in the nanoliter (nl) range. A microchannel structure comprises all the functionalities (functional units) for performing an experiment or protocol that is to be performed within the device. A microchannel structure thus contains one or more microcavities and/or microconduits that have at least one, two or more cross-sectional dimensions that are ≦10³ μm, preferably ≦5×10² μm, such as ≦10² μm (i.e. the microchannel structure is in the microformat). Typical cross-sectional dimensions are depth and width. The nl-range has an upper limit of 5,000 nl. In most cases it relates to volumes ≦1,000 nl, such as ≦500 nl or ≦100 nl.

A microchannel structure thus may comprise one, two, three or more functional parts or units selected among: a) inlet arrangement comprising for instance an inlet port/inlet opening, possibly together with one or more volume-metering units, b) microconduits for liquid transport, c) reaction microcavity/unit; d) mixing microcavity/unit; e) unit for separating particulate matters from liquids (may be present in the inlet arrangement), f) unit for separating dissolved or suspended components in the sample from each other, for instance by capillary electrophoresis, chromatography and the like; g) detection microcavity/unit; h) waste conduit/microcavity/unit; i) valve; j) vent to ambient atmosphere; k) anti-wicking function; l) liquid directing function etc. A functional part may have two or more functionalities, for instance: a reaction microcavity and a detection microcavity may coincide; a volume metering function may comprise a metering microcavity together with one or more valve functions and/or one or more anti-wicking functions; a reaction microcavity may comprise one or more valve functions and/or anti-wicking functions; a passive valve function based on a non-wettable surface break may comprise also an anti-wicking function etc.

Various kinds of functional units in microfluidic devices have been described by Gyros AB/Amersham Pharmacia Biotech AB: WO 9955827, WO 9958245, WO 02074438, WO 0275312, WO 03018198, WO 03024598, SE 0302650-7, SE 0400071-7 and U.S. Ser. No. 60/508,508, and SE 04008488 and corresponding US provisional filed on the same day, and by Tecan/Gamera Biosciences: WO 0187487, WO 0187486, WO 0079285, WO 0078455, WO 0069560, WO 9807019, WO 9853311. See also U.S. Pat. No. 6,926,020; U.S. Pat. No. 6,591,852; U.S. Pat. No. 6,601,613; and U.S. Pat. No. 6,637,463 (all Biomicro), each of which is incorporated herein by reference in its entirety.

The microfluidic device may also comprise common microchannels/microconduits that connect two or more microchannel structures. Common channels/conduits including their various parts such as inlet ports, outlet ports, vents, etc., are considered part of each of the microchannel structures they are common for.

Each microchannel structure has at least one inlet opening for liquids and at least one outlet opening for excess of air (vents). An outlet opening having a vent function may in many cases also function as an outlet for liquids.

The number of microchannel structures per device is typically ≧10, e.g. ≧25 or ≧90 or ≧180 or ≧270 or ≧360.

Different principles may be utilized for transporting the liquid within the microfluidic device/microchannel structures between two or more of the functional parts described above. Inertia force may be used, for instance by spinning the disc as discussed in the subsequent paragraph. Other useful forces are electrokinetic force, non-electrokinetic forces such as capillary force, hydrostatic pressure etc.

A microfluidic device typically is in the form of a disc. The preferred formats have an axis of symmetry (Cₙ) that is perpendicular to or coincides with the disc plane. In the former case n is an integer ≧2, 3, 4 or 5, preferably ∞(C_{∞}). In the latter case n is typically 2. In other words the disc may be rectangular, such as in the form of a square, or have other polygonal forms. It may also be circular. Once the proper disc format has been selected centrifugal force may be used for driving liquid flow, e.g. by spinning the device around a spin axis that typically is perpendicular to or parallel with the disc plane. Parallel in this context includes also variants for which the spin axis coincides with the disc plane. In the most obvious variants at the priority date, the spin axis coincides with the above-mentioned axis of symmetry which both are perpendicular to the disc plane. See the publications given above. Preferred variants in which the spin axis is not perpendicular to the disc plane are given in PCT/SE03/01850, which is incorporated herein by reference in its entirety.

For preferred centrifugal-based variants, each microchannel structure comprises an upstream section that is at a shorter radial distance from the spin axis than a downstream section. Spinning of the device around this spin axis create centrifugal force that will induce transportation of liquid from the upstream section to the downstream section for the proper design between the sections. See the patent publications discussed above dealing with this kind of microfluidic devices.

The preferred devices are typically disc-shaped with sizes and forms similar to the conventional CD-format, e.g. sizes that corresponds to CD-radii that are the interval 10%-300% of the conventional CD-radii (about 12 cm). The upper and/or lower sides of the disc may or may not be planar.

The device is typically made in plastics by which is contemplated that in a typical device at least the microchannel structures and/or only certain microconduit parts thereof are fabricated or formed in plastics. Other parts of the device are often also made in plastics. The microchannel structure of a device may thus be fabricated in a layer of plastics that in the final devices is resting on or otherwise combined with one or more other material.

In preferred variants, the manufacture of the device comprises the subaspect of the second aspect outlined in the two last paragraphs under the heading “Step (i): providing local surface areas S”. The non-wettable breaks/fluidic functions do not need to be introduced in accordance to the second aspect.

F. Wettability of Surfaces of Plastic Materials

The wettability of plastic material typically is too poor for allowing efficient capillary liquid transport within a microchannel structure/microconduit manufactured in plastics. Therefore the inner walls that are made in plastics are preferably made wettable before non-wettable surface breaks are introduced. For the second aspect of the invention this means that a local surface area S is in most cases provided in a wettable form in step (i). In the case of microconduits/microchannel structures that are defined between two substrates (I and II) each of which has a side (side_{I} and side_{II}) that comprises complementary parts of the microconduits as discussed in the context of the second aspect, sufficient wettability may be introduced on at least one of side_{I} and side_{II} before apposing the sides/substrates. A complementary part may appear as a physical microstructure on one or both of the sides. Wettability is typically introduced at least on a microstructured side.

Well-known protocols for introducing wettablity includes plasma treatment, for instance in the presence of inorganic precursors, such as oxygen, nitrogen, carbon dioxide etc, and/or hydrophilic organic precursors, such as formaldehyde, methanol, various compounds containing repetitive ethylene oxide structures (—CH₂CH₂O)ₘ (where m is >1) and other organic compounds of relatively low molecular weights comprising a relatively high ratio of O— and/or N-heteroatoms to carbon atoms. See for instance WO 00056808 and WO 03086960, each of which is incorporated herein by reference in its entirety.

Masking/demasking is utilized to accomplish introduction of wettability on selected parts of a substrate side.

Alternatively various coating techniques that utilize liquids containing hydrophilic organic compounds that can be attached to the plastic surface either by adsorption (non-covalently) and/or chemically (covalently). The organic compounds utilized may be of low molecular weight (<1000 dalton) or have large molecular weight, e.g. be polymeric (≧1000 dalton). If needed the compounds are attached directly to the surface or transformed to entities that are capable of doing so. A wettable layer introduced in this way may be cross-linked, during or after its formation. When using liquids containing wetting coating agents, introduction of wettability may be carried out with the microconduit in enclosed, e.g. the complete microchannel structure enclosed such as in the final device.

Wettability of surfaces of plastic materials typically means that the surface will expose polar functional groups comprising at least one heteroatom selected amongst oxygen, nitrogen and sulfur. Typical functional groups are carboxy (—COOH/—COO⁻), ester (—C(═O)O—), hydroxy (—OH), ether (—O—), amido (—C(═O)NR′—), amino/ammonium (—N═/—N⁺≡) etc with free valences binding to sp³-carbons or hydrogens. An ether group may be part of a single ether group or be present in a poly ether structure, for instance be a poly(alkylene oxide) chain that may be built up of different and/or identical alkylene oxide groups each of which has 1, 2, 3, 4, 5, 6 or more carbon atoms. A poly(alkylene oxide) chain may comply with the formulae —(O)_{n′}[(CH₂)_{n″}O]_{n′″}—. where n′ is 0 or 1, n″ is an integer 1, 2, 3, 4, 5 or 6, and n′″ is 1, 2, 3, 4, or more, for instance ≦100, such as ≦50 or ≦25 or ≦10. Either one or both of the hydrogens in a CH₂ group may be replaced with a lower alkyl. Segments of polyalkylene oxide chains which differ with respect to n′, n″, n′″ and substitution of hydrogens may be linked to each other. In the preferred chains n′ is 0 or 1, n″ is 2, and n′″≧2, i.e. the chain is a polyethylene oxide.

The water contact angle for surfaces of inner walls that have been made wettable is typically as discussed elsewhere in this specification for hydrophilic microconduits.

IV. Method for the Manufacture of a Fluidic Function

The second aspect of the invention is a method of production of the type fluidic function given in the introductory part. The method is characterized by the steps:
(i) providing at least one local surface area S of the kind defined in the introductory part;
(ii) contacting this at least one local surface area S with a composition containing a fixatable fluoropolymer (fluoropolymer composition); and
(iii) fixating the fluoropolymer to this at least one local surface area S.

A. Step (i): Providing Local Surface Areas S

The variants may include, for example, the local surface areas S are associated with openings of microchannel structures as they physically appear in the final microfluidc device. The surface areas S are in this step provided on a substrate that comprises the microchannel structures or on a part of the substrate which part comprises this kind of openings. Steps (ii)-(iii) are carried out on either the substrate or on the part substrate. In another variant, the local surface areas S are a part of inner walls of microchannel structures as they physically appear in the final microfluidic device. In this variant there are two main alternatives for the introduction of the desired non-wettability: performing at least step (ii) while microconduits that comprise this kind of local surface areas are in unenclosed form, and performing both steps (ii) and (iii) while microconduits that comprise this kind of local surface areas are in enclosed form, e.g. with the corresponding microchannel structures enclosed as they physically appear in the final device. Another variant is a combination of the first and the second variant. Certain local surface areas S are associated with inner surfaces and other local surface areas S with openings in the outer surfaces of the device. Surface areas S are made non-wettable according to the first or the second variant depending on where they are located.

In an attractive variant the microconduit that comprises a local surface area S on which non-wettability is to be introduced is initially exposed as two complementary parts with each part being present in one side of a substrate material. In other words one of the complementary parts is present in one side (side_{I}) of a first substrate I while the other complementary part is present in one side (side_{II}) of a second substrate II. When the sides are apposed to each-other, the microconduit will form between the substrates/sides. In the most typical case one or both of the complementary parts is obtained by microstructuring side_{I} and/or side_{II}. Micro-structured in this context includes physical microstructures and/or microstructuring with respect to chemical surface characteristics, such as wettability and non-wettability. In a preferred variant one of side_{I}, and side_{II} exposes a groove system while the corresponding part of the other side is smooth/flat or comprises a complementary groove system.

Other sections of a microchannel structure than the microconduit containing the local surface area(s) S are defined between substrate I and substrate II and/or between other pairs of substrates. The side (side_{II}^{opp}) that is opposite to side_{II} in substrate II may thus be apposed to one side (side_{III}) of a third substrate III in which case the complementary parts of this section is located in side_{II}^{opp} and side_{III}, respectively. Connecting microconduits between sections that are defined between different pairs of substrates may then be formed by one or more holes passing through a substrate, such as substrate II. The inner walls of microconduit sections defined between other pairs of substrates than substrates I and II may also comprise local surface areas on which non-wettability is to be or already has been introduced, for instance according to the instant invention.

In a subaspect of the innovative method the microfluidic device produced thus has the layered structure described in the preceding paragraphs. A characterizing feature of this subaspect is that one or more of said at least one local surface area S are present in a side (side_{I}) of a first substrate I while other local surface area(s) S are present on a side (side_{II}) of a second substrate II; at least one of side_{I} and side_{II} is microstructured such that the microconduit is formed when these two sides are apposed; side_{I} and side_{II} are provided non-apposed to each other; and the method comprises a fourth step (step (iv)) in which side_{I} and side_{II} are apposed to each other to form the hydrophilic microconduit between steps (i) and (ii) or between steps (ii) and (iii) or subsequent to step (iii).

Each of the substrates discussed above is typically made of plastics. Physical microstructures may be introduced by replication, such as embossing, injection moulding, compression moulding etc and other microfabrication techniques such as etching, laser ablation, lithography etc as well-known in the field. In an alternative variant at least a part of the physical microstructures that correspond to the microconduit that comprises a local surface area S are introduced in the form of one or more intermediary microstructured substrates. The microstructures of an intermediary substrate are then in the form of a pattern-punched-out from the substrate. Intermediary substrates that define the microconduit comprising a local surface area S is placed between substrate I and II and are considered to belong to either substrate I or substrate II. See U.S. Pat. No. 5,376,252, which is incorporated herein by reference in its entirety.

B. Step (ii): Contacting and the Fluoropolymer

The fluoropolymer composition is typically in liquid form and contains the fluoropolymer in dissolved form (solution). The fixating ability of the fluoropolymer resides in the fluoropolymer as such and/or in other components of the composition. The solvent is typically a fluorinated organic solvent or some other organic solvent that may be aqueous and capable of dissolving or dispersing the used fluoropolymer composition.

The fixatable fluoropolymer is in preferred variants selected amongst the fluoropolymers discussed for the first aspect.

The fluoropolymer composition may comprise a component (binding agent) that is capable of increasing adherence of the fluoropolymer to a local surface area S during the fixating step (step (iii)). Such binding agents may act by initiating formation of chemical bonds between the fluoropolymer and the surface and/or of inter- and/or intramolecular chemical bonds in relation to the fluoropolymer. The binding agent may also be a resin that upon removal of liquid from the composition forms a solid layer on the local surface. The layer then will comprise and expose the fluoropolymer on its surface. The resin may be curable and may or may not exhibit fluoro groups.

C. Step (ii) Variants:

In Step (ii), the variants may include but are not limited to the fluoropolymer is synthesized prior to being brought into contact with a local surface area S, and the fluoropolymer is formed in situ on the local surface area S.

Formation in situ comprises, for instance, contacting a local surface area S with a liquid composition that contains the corresponding fluoromonomers if required together with a polymerization initiator (polymerization mixture). The monomers are subsequently polymerized while maintaining the composition in contact with the local surface area S. Depending on the selected initiator (if present), monomer(s) etc, the polymerization may be started by increasing the temperature (thermal polymerization), irradiating for instance with UV (irradiation polymerization), a chemical reaction (chemical polymerization) etc. Depending on the particular system applied a thermal initiator, irradiation initiator (e.g. UV initiator), chemical initiator etc will typically be required.

The starting polymerization mixture may contain a presynthesized fluoropolymer in addition to the fluoromonomers. This presynthesized fluoropolymer and the fluoropolymer formed in situ may be of the same or of different kind, and may support the fixating of the fluoropolymer to the local surface area S. The presynthesized fluoropolymer may thus act as a binding agent as suggested above.

The solid content of the fluoropolymer composition when in liquid form typically constitutes from about 0.01% by weight to about 50% by weight of the total composition. In preferred variants the solid content typically lies within the interval of 0.1-5%. Soluble monomers that are present in the starting composition and polymerized in the innovative method are part of the solid content.

Suitable compositions can be selected from those that are described in U.S. Pat. No. 6,447,919 (which is incorporated herein by reference in its entirety) and are also commercially available from Cytonix Inc and other companies such as 3M, Dupont, Aldrich.

The fluoropolymer composition may be applied to a local surface area S by printing, stamping, painting, spraying and the like, typically after masking those parts of the surface that are outside the local surface area S. In the case the fixating step enables local fixation, for instance by the application of heat or irradiation, the contacting step may include also contact between the fluoropolymer composition and surface areas surrounding the individual local surface areas S. In this latter case masking may be utilized during the irradiation so that fixation only takes place on the irradiated local surface areas S (local fixation). If the microconduit is in enclosed form the composition is preferably applied by filling the microconduit with the composition followed be local fixation (see step (iii)).

The fluoropolymer composition may be formed on the local surface area S by stepwise addition of its components.

The liquid/solvent components of the composition may or may not be removed before the fixating steps starts, i.e. the fixating step starts with the fluoropolymer composition in a dried or a non-dried form.

D. Step (iii): Fixating

The fixating step enhances the adherence of the fluoropolymer to the local surface area S.

The result of the fixating step can be measured as an increased ability of the fluoropolymer to remain adhered to the local surface area S during contact with an aqueous liquid under static or flow conditions, for instance as illustrated in the experimental part for solution A (50% acetonitril, 0.1% trifluoroacetic acid), solution B (PBS-Tween™) or solution C (PBS-Tween™, 20% 2-propanol (isopropanol) at room temperatur (25° C.).

The fixating step thus contemplates that the water contact angle of the surface becomes less prone to changes and/or the fluoropolymer and/or the layer created becomes less prone to be removed upon treatment with one or more of the solutions mentioned compared to without the fixating step.

Testing typically comprises that measurements are made after time periods of different lengths for the contact between the solution (A, B or C) and the formed fluoropolymer surface. Alternatively the contact is repetitive and the number of times the surface resist the treatment is taken as a measure of the increased adherence (the same length of contact each time). Measurements are made with the local surface area in a dry state.

In one variant fixation means inter- and/or intramolecular cross-linking of components of the fluoropolymer composition including a possible binding between one or more of these components and the local surface area S. The bonds created may be of covalent and/or electrostatic nature (ionic) and involves in particular the fluoropolymer and/or, if present, one or more of the components that act as binding agent. This kind of cross-linking typically depends on the presence of distinct reactive species in the composition, and/or on functional groups in the fluoropolymer. Cross-linking may start by itself, in which case the fixating step fully or partially may coincide with the contacting step (step ii). Alternatively, cross-linking has to be initiated actively, for instance by irradiation, heating, and/or addition of reactive species (initiators) after the contacting step. See for instance U.S. Pat. No. 6,447,919 (which is incorporated herein by reference in its entirety). Reactive species in this context contemplates components of the fluoropolymer composition other than the fluoropolymer and they typically exhibit functional groups in which there are one, two or more heteroatoms selected amongst oxygen, nitrogen and sulphur, or a carbon-carbon double bond.

In certain aspects, irradiation, for instance with ultraviolet light, may lead to fixating of the fluoropolymer even when the fluoropolymer composition is devoid of separate reactive species, such as initiators. This in particular applies for the preferred fluoropolymers discussed above. The reason for this fixating effect is at the present stage unknown, but it is believed that the effect may depend on derivatization, degradation, aggregation and/or conformational changes of the fluoropolymer with the consequence that formed forms have an enhanced ability to adhere to the local surface area S. It can be envisaged that derivatization, degradation, aggregation and/or conformational changes that stabilize a non-wettable surface coat on a local surface area S may also occur upon storage and/or at elevated temperatures and the like.

Thus fixating in the context of the present invention in particular contemplates irradiation, such as with UV, and/or heating of the local surface areas S after step (ii). Reactive species as defined above may or may not be present in the flouropolymer composition applied in step (ii). The exact choice of irradiation, for instance wave length, temperature, reactive species and/or length of the time period for the fixation will depend on the fluoropolymer and other components of the fluoropolymer composition and also on the chemical surface characteristics of the local surface areas S. Irradiation is typically with UV light of a wave length that at least partially is within the range of 100-400 nm and in most cases encompasses a band width of at least 50 nm, such as at least 100 nm or at least 200 nm. Also other kinds of irradiation may potentially be used, such as gamma-irradiation, electron irradiation etc. Suitable heating temperatures are typically found in the interval +30° C. to +150° C. with due care taken for avoiding approaching the softening temperature of the plastic material that supports the local surface area S.

### V. EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Manufacture of Smooth Innovative Non-Wettable Surfaces

MATERIALS

| Chemical | Manufacturer | Description |
|---|---|---|
| Cytonix ™ PFC-602A | Cytonix | 2% fluoroaliphatic polymer |
| | | in HFE-7100 |
| Teflon ™ NP 2400 | Dupont | Poly[4,5-difluoro-2,2- |
| | | bis(tri-fluoromethyl)-1,3- |
| | | dioxole-co- |
| | | tetrafluoroethylene |
| HFE ™-7100 | 3M | Fluorinated solvent |
| FC ™-75 | 3M | Fluorinated solvent |
| 1H,1H,2H,2H-perfluoro- | Aldrich | Fluorinated methacrylate |
| decylmethacrylate (C10F) | | Monomer |
| Esacure ™ TZT | Lamberti | UV-initiator |

EQUIPMENT

| Instrument | Manufacturer | Description |
|---|---|---|
| Gyrolab ™ Workstation | Gyros AB | WO 02075312, |
| | | PCT/SE2004/000440, |
| | | PCT/SE2004/000441 (all of |
| | | Gyros AB). |
| PS 500 | Plasma Science | Plasma reactor |
| Efsen 500W Hg-lamp | Efsen | UV-lamp |

Methods

Microfluidic device: The device was in the form of a circular disc of the same size as a conventional CD. The microchannel structures were in principle of the same design and function in the same way as the structures in FIGS. 7a and b in WO 02075775 (which is incorporated herein by reference in its entirety). The main difference is that the CD used to evaluate the invention comprised segments of 17 microchannel structures each compared to 10 in WO 02075775, which is incorporated herein by reference in its entirety. The structures and segments are arranged in an annular fashion around the centre of the disc.

The structures are shown in FIG. 1 in which each microchannel structure (1 . . . e . . . l . . . ) starts at a common inlet port (2) and ends at an outlet port (3 . . . e . . . l . . . ). In addition there is one separate inlet port (4 . . . e . . . l . . . ) per microchannel structure. Each outlet port (3 . . . e . . . l . . . ) functions as a combined area for evaporation and for detection by MALDI mass spectrometry. There is also a common distribution manifold (5) containing one volume-metering microcavity (6 . . . e . . . l . . . ) per microchannel structure and a common microconduit (12).

There are four kinds of local non-wettable breaks (7,8,9,10,11) each of which is associated with a fluidic function. Break (7) is placed on the outer surface of the microfluidic device in association with an inlet opening/port (2) and has a liquid-directing function which guides liquid into the inlet port (2). In the same manner each break (8 . . . e . . . l . . . ) guides liquid into the inlet ports (4 . . . e . . . l . . . , respectively). Each break (9 . . . e . . . l . . . ) is also on the outer surface of the device but is associated with an outlet port (3 . . . e . . . l . . . ) and assists in retaining liquid that has passed through a structure (1 . . . e . . . l . . . ) in the inlet port (3 . . . e . . . l . . . ) while evaporation takes place. Breaks (10 . . . e . . . l . . . ) are valve functions each of which is used for metering a liquid aliquot in the corresponding volume-metering microcavity (6 . . . e . . . l . . . ). Breaks (11 . . . e . . . l . . . ) will have both anti-wicking function and liquid-directing function.

Not shown is that each of the left and the right extreme (13a,b) of the distribution manifold ends in a microconduit in which there are a) a local non-wettable surface area that functions as a valve, and b) an outlet port further out from the valve function. These outlet ports and valves are at a larger radial distance from the centre of the disc than the breaks (10 . . . e . . . l . . . ). See WO 02075775 (which is incorporated herein by reference in its entirety).

Each microchannel structure will comprise eight local non-wettable surface areas. These are for structure 1e: 7 (liquid directing), 8e (liquid directing), 10e (valve), 11e and 11f (liquid directing/anti-wicking)(not expressly numbered in FIG. 1), 9e (liquid directing) and the valve function (not shown) in each of the two microconduits starting at the extremes (13a and 13b, respectively). The flow path going from inlet port (2) to outlet port (3e) will comprise seven local non-wettable surface areas, which are the same as for the microchannel structure except liquid directing function (8e). The flow path going from inlet port (8e) to outlet port (3e) will only comprise two of these surfaces, i.e. liquid directing function 8e and liquid directing function 9e.

CD preparation: Microstructured Zeonor™ circular discs were prepared by injection moulding and their microstructured surfaces were hydrophilized by O₂ plasma-treatment, masked and sprayed with non-wettable coating (fluoropolymer composition) to form the non-wettable surface breaks (10-11) and the non-wettable surface breaks in the two microconduits at the extremes (13a,b). See WO 00056808 (which is incorporated herein by reference in its entirety). The microstructure concerned is given in FIG. 1. The mask was removed and a laminate lid was heat sealed to the microstructured surface forming the fourth wall of the microstructures. See WO 01054810 (which is incorporated herein by reference in its entirety). The hydrophobic surface breaks (7,8,9) were introduced after masking the device with a lid and spraying with the fluoropolymer composition. UV-fixating of the non-wettable coatings was performed by illuminating the finished circular microfluidic discs (CD) 2 minutes at a distance of 13 cm with a 500W Efsen Hg-lamp.

Microfluidic evaluation: Evaluation of hydrophobic valves was carried out using the Gyrolab™ microfluidic platform. A number of different fluids were loaded on the CD using an autopipette and passed over the hydrophobic valves by application of centrifugal force. The width of the channel at the hydrophobic valve was 100 μm and the depth was 40 μm. The number of times a fluid can be passed over a hydrophobic valve without the valve losing performance gives an indication of the durability of the valve. In this example three different fluids were used:
A: 50% acetonitrile, 0.1% trifluoroacetic acid
B: PBS-Tween™
C: PBS-Tween™, 20% 2-propanol

Fluid A was added to different segments on the CD via the common inlet port (2). Fluid filled up the distribution manifold (5) by capillary force to the first valve function, i.e. to the surface breaks (10 . . . e . . . l . . . ) and to the surface breaks in the microconduits in the extremes (13a,b) (not shown). Upon spinning at a first speed the common microconduit (12) was emptied via the outlet ports in the extremes (13a,b) leaving liquid only in the volume-metering microcavities (6 . . . e . . . l . . . ). This emptying is assisted by the liquid-directing function of breaks (11 . . . e . . . l . . . ). By increasing the spin the metered aliquots in the volume-metering microcavities (6 . . . e . . . l . . . ) will then pass through the valve functions at surface breaks (10 . . . e . . . l . . . ). and down into the outlet ports (3 . . . e . . . l . . . ). The surface breaks (11 . . . e . . . l . . . ) will now function as anti-wicking means preventing wicking between the volume-metering microcavities (6 . . . e . . . l . . . ).

This procedure was repeated until one of the valve functions in the segment failed.

The same procedure was then performed for fluids B and C in other segments.

TABLE 1
Results from microfluidic testing

| Hydrophobic | Addi- | | | No. fluid rinses | | |
|---|---|---|---|---|---|---|
| part | tives | Solvent | UV | A | B | C |
| Cytonix | — | HFE-7100 | No | 1 | 4 | 1 |
| PFC ™-602A | | | | | | |
| Cytonix ™ | — | HFE-7100 | Yes | >10 | >10 | >10 |
| PFC-602A | | | | | | |
| Teflon ™ AF | — | 50% FC-75, | No | 1 | 0 | 0 |
| 2400, 0.5% | | 40% HFE-7100, | | | | |
| | | 10% acetone | | | | |
| Teflon ™ AF | — | 50% FC-75, | Yes | 3 | 3 | 3 |
| 2400, 0.5% | | 40% HFE-7100, | | | | |
| | | 10% acetone | | | | |
| Teflon ™ AF | 0.5% | 50% FC-75, | Yes | >10 | >10 | >10 |
| 2400, 0.5% | C10F, | 40% HFE-7100, | | | | |
| | 0.1% | 10% acetone | | | | |
| | TZT | | | | | |

The local non-wettable surface areas were also inspected visually before and after microfluidic testing using an optical microscope. The areas were checked for visible damage from cracking or flaking that might impair their ability to stop fluids.

No failure or visible damage was observed for any of the surface breaks 7,8,9,10,11 and the surface breaks in the two microconduits in the extremes (13a,b).

### Example 2

### Preparation of Rough Non-Wettable Surfaces

0.4-2.0% (w/w) Aerosil™ R972 methylated silica colloids (DeGussa, d=11 nm) were added to a 0.05% solution of Teflon-AF™ 2400 (DuPont Polymers, DE, USA). The mixture was applied by spraying or dipping onto Zeonor™ 1420R (Zeon Corp., Japan) which had been surface treated with an oxygen plasma (Plasma Electronic, Germany). The resulting surfaces had advancing/receding water contact angles of 165-170°/130-170°.

2% (w/w) Aerosil™ R972 was added to PFC602A (Cytonix Corp., MD, USA), which is a 2% solution of polyperfluorooctylmethacrylate in HFE-7100 (3M Belgium N.V.). Sprayed or dipped surfaces had advancing/receding water contact angles of 169-174°/˜165°.

The adhesion of these coatings to oxygen plasma-treated Zeonor™ could be greatly improved by mixing, for example 2% PFC602A in a 1:1 ratio with perfluorodecylmethacrylate and 0.1-0.4% Esacure™ TZT (Lamberti, Italy) and 1% Aerosil™ R972. The mixture required the addition of acetone (10%) in order to dissolve Esacure™ TZT. After drying, the coating was cured by illumination under a UV-lamp for 2 minutes (500 W, Efsen, Denmark). The resulting coating was wash stable to 95% ethanol, and had advancing/receding water contact angles of ˜175°/135°.

Measurement of Contact Angles: Water contact angles were measured using a Ram é-Hart goniometer. Advancing contact angles were determined by increasing the drop volume until the contact line just started to move. The receding contact angle was determined in a similar way upon decreasing the drop volume.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method for processing two or more liquid aliquots in a microchannel structure of a microfluidic device which microchannel structure comprises a hydrophilic microconduit with a fluidic function, which is based on a local non-wettable surface area associated with the microconduit, wherein said processing comprises the steps of:
(i) passing a liquid aliquot (aliquot I) that contains one or more components selected from the group consisting of organic solvents and surface active entities through the microconduit, and
(ii) passing another liquid aliquot (aliquot II) through the microconduit,
wherein said local non-wettable surface area exposes fluoro groups (F—) on its surface and/or comprises a rough part.

2. The method of claim 1, wherein said local non-wettable surface area is located within the microconduit.

3. The method of claim 1, wherein said fluidic function is selected from the group consisting of passive valve functions, anti-wicking functions, vent functions, and liquid-directing functions.

4. The method of claim 1, wherein in aliquot I and aliquot II have a common flow path which is utilized during their transportation and processing in a microchannel structure, and the local non-wettable surface area occurs more than three times in the common flow path.

5. The method of claim 1, wherein the local non-wettable surface area occurs more than four times in the microchannel structure.

6. The method of claim 1, wherein said components comprises an organic solvent constituting ≧1% of aliquot I.

7. The method of claim 1, wherein said components comprises an organic solvent constituting ≧10% of aliquot I.

8. The method of claim 1, wherein said components comprises surface-active components constituting ≧0.1 μg/ml of aliquot I.

9. The method of claim 1, wherein said components comprises surface-active components constituting ≧10 μg/ml of aliquot I.

10. The method of claim 1, wherein said components comprises surface-active components selected from the group consisting of bio-organic molecules and detergents.

11. The method of claim 10, wherein said surface-active components comprises bio-organic molecules constituting ≧0.1 μg/ml of aliquot I.

12. The method of claim 10, wherein said surface-active components comprises bio-organic molecules constituting ≧10 μg/ml of aliquot I.

13. The method of claim 10, wherein said surface-active components comprises bio-organic molecules exhibiting peptide structure ≧0.1 μg/ml of aliquot I.

14. The method of claim 10, wherein said surface-active components comprises bio-organic molecules exhibiting peptide structure ≧10 μg/ml of aliquot I.

15. The method of claim 10, wherein said surface-active components comprises detergents constituting ≧0.1 μg/ml of aliquot I.

16. The method of claim 10, wherein said surface-active components comprises detergents constituting ≧1 μg/ml of aliquot I.

17. The method of claim 1, wherein aliquot I is a body fluid sample that is undiluted or diluted.

18. The method of claim 1, wherein aliquot I is a body fluid sample that is diluted ≦1:10000.

19. The method of claim 1, wherein aliquot I is a body fluid sample that is diluted ≦1:100.

20. The method of claim 1, wherein aliquot I is a body fluid sample that is a serum or plasma sample.

21. The method of claim 1, wherein said processing comprises passing one or more additional liquid aliquots through the microconduit before step (i) and/or between steps (i) and (ii) and/or after step (ii).

22. The method of claim 1, wherein at least one of aliquot I or aliquot II contains a reactant needed for carrying out the processing.

23. The method of claim 21, wherein at least one aliquot of said additional aliquots contains a reactant needed for carrying out the processing.

24. The method of claim 23, wherein two or more of said at least one aliquot contain a reactant that is different in at least two of said additional aliquots.

25. The method of claim 22, wherein the reactant in said at least one aliquot is an analyte and the processing is part of an analytical protocol.

26. The method of claim 25, wherein the analyte is aliquot I or aliquot II.

27. The method of claim 1, wherein said fluidic function is a valve function, step (i) comprises pausing aliquot I at said valve function, and step (ii) comprises pausing aliquot II at said valve function.

28. The method of claim 27, wherein said valve function is at the outlet end of a liquid retaining microcavity.

29. The method of claim 28, wherein said valve function is at the outlet end of a volume-defining unit comprising a volume-metering microcavity comprising said outlet end, and metering a liquid volume as a consequence of step i) pausing the aliquot at the valve function, and step ii) transporting the liquid volume retained in the metering-microcavity during pausing downstream in the microchannel structure through said outlet end.

30. The method of claim 1, wherein one or more of said fluoro groups are exposed on said non-wettable surface area and are selected from the group consisting of CF₃—, CHF₂—, CH₂F—, —CF₂— and —CHF— groups in which a free valence is binding to a carbon atom.

31. The method of claim 1, wherein one or more of said fluoro groups are exposed on said non-wettable surface area and are selected from the group consisting of CF₃—, CHF₂—, CH₂F—, —CF₂— and —CHF— groups in which a free valence is binding to a sp³- or sp²-hybridized carbon atom.

32. The method of claim 1, wherein one or more of said fluoro groups are exposed on said non-wettable surface area and are part of a fluoropolymer.

33. The method of claim 1, wherein one or more of said fluoro groups are exposed on said non-wettable surface area and are part of a fixatable fluoropolymer that is fixated to said surface.

34. The method of claim 1, wherein one or more of said fluoro groups are exposed on said non-wettable surface area and are part of a fluoropolymer that comprises polymerized fluoro-containing alkene monomers.

35. The method of claim 1, wherein said non-wettable surface area is rough.

36. The method of claim 1, wherein said non-wettable surface area is rough with a roughness within the interval 0.01-15 μm.

37. The method of claim 1, wherein said microfluidic device comprises a plurality of said microchannel structure, and steps (i)-(ii) are carried out essentially parallel in at least two or more of these microchannel structures without failure of said fluid function in any of said at least two or more microchannel structures.

38. A method for producing a fluidic function that is based on the presence of a local non-wettable surface area in a hydrophilic microconduit of a microchannel structure that is present in a microfluidic device made in plastics, said method comprising introducing non-wettability on at least one local surface area S, each of which is
(a) a part of an inner wall of said microconduit, or
(b) associated with the outer surface at an opening to ambient atmosphere of said microconduit,
said method comprises the steps of:
i) providing said at least one local surface area S;
ii) contacting this at least one local surface area S with a fixatable fluoropolymer; and
iii) fixating the fluoropolymer to this at least one local surface area S.

39. The method of claim 38, wherein one or more of said at least one S are according to alternative (b).

40. The method of claim 38, wherein one or more of said at least one S are according to (a).

41. The method of claim 38, wherein one or more of said at least one S are according to (a) and are wettable.

42. The method of claim 38, wherein
i. one or more of said at least one local surface area S are present in a side (side_{I}) of a first substrate I while one or more other local surface areas S are present on a side (side_{II}) of a second substrate II;
ii. at least one of side_{I} , and side_{II} is microstructured such that the microconduit is formed when these two sides are apposed;
iii. side_{I} and side_{II} are provided non-apposed to each other; and
iv. apposing side_{I} and side_{II} to each other to form the microconduit (step iv) between steps (i) and (ii), or between steps (ii) and (iii), or subsequent to step (iii) during which side_{I} and side_{II} are apposed to each other to form the microconduit.

43. The method of claim 38, wherein said fluidic function is selected from the group consisting of anti-wicking functions, valve functions, vent functions and liquid-directing functions.

44. The method of claim 38, wherein said fixatable fluoropolymer comprises the monomeric unit
—CR₁R₂—CR₃R₄—
in which R₁₋₄ are identical or equal with at least one of them containing fluoro (fluoro-containing group) and the others are selected from the group consisting of hydrogen, fluoro, lower alkyls and hydrogen.

45. The method of claim 44, characterized in that one or more of said at least one fluoro containing group comply with the formula —BₙR where n is 0 or 1, B is a bivalent organic group containing a heteroatom selected from the group consisting of oxygen and nitrogen, and R is fluoro provided n is 0, or a monovalent or bivalent polyfluorinated straight, branched or cyclic alkyl.

46. The method of claim 44, wherein two of R₁₋₄ form a bivalent group that together with either one or both of the carbons of the unsaturation form a cyclic structure.

47. The method of claim 44, wherein said one or more of said at least one fluoro-containing group comply with the formula —BₙR in which n is 1 and B comprises at least one bivalent group selected amongst ether (—O—), ester (—COO—), amide (—CONR′—), amine (—NR″—) where each of R′ and R″ is selected from the group consisting of lower alkyls each of which has 1-12 sp³-hybridised carbons.
